(19) United States
(12) Patent Application Publication
(10) Pub. No.: US 2026/0204141 A1
(43) Pub. Date: Jul. 16, 2026

(54) TOURNAMENT APPLICATION SYSTEM AND METHOD OF PARTICIPATION / OPERATION THEREOF

(71) Applicant: Winzo Games Private Limited, New Delhi (IN)

(72) Inventors: Saumya Singh Rathore, New Delhi (IN); Paavan Nanda, New Delhi (IN); Dhiraj Kumar Bedi, New Delhi (IN); Manish Mittal, New Delhi (IN)

(21) Appl. No.: 19/360,309

(22) Filed: Oct. 16, 2025

Related U.S. Application Data
(63) Continuation-in-part of application No. 17/866,661, filed on Jul. 18, 2022, now abandoned.

(30) Foreign Application Priority Data
Mar. 8, 2022 (IN) 202211012413

(51) Int. Cl. G07F 17/32

(52) U.S. Cl. CPC G07F 17/3276; G07F 17/3293

(57) ABSTRACT

A tournament application system and method of participation and operation is disclosed herein. The tournament application system and method includes an application system with a computing system capable of interacting with a plurality of users. A server including a module arranged to interact with a plurality of users to operate a game containing a plurality of levels, the system being arranged to operate a tournament structure. The tournament application system includes tournaments which have multiple teams in each game. The method includes the steps of: a) users taking part in an event by grouping themselves into teams; b) the players being able to join the tournament or game at any stage of the tournament; c) the tournament application system provides short tournament in a team format where the teams can be of equal or unequal strength.

### CLAIM OF PRIORITY/CROSS-REFERENCE TO RELATED APPLICATION

The present application is a Continuation-In-Part Patent Application of U.S. patent application Ser. No. 17/866,661 filed on Jul. 18, 2022, which is based on and claims foreign priority to Indian Patent Application No. 202211012413, filed on Mar. 8, 2022.

The contents of both of the above-referenced prior applications, namely, U.S. patent application Ser. No. 17/866,661 filed on Jul. 18, 2022 and Indian Patent Application No. 202211012413, filed on Mar. 8, 2022, are incorporated herein in their entirety by reference.

### FIELD OF THE INVENTION

The present invention generally relates to a tournament application system. More particularly, the present invention relates to a tournament application system arranged to conduct a tournament on a computing system such as one or more mobile devices.

### BACKGROUND OF THE INVENTION

With reference to US patent application no. US20090011810A1 by WATERLEAF LIMITED dated Apr. 25, 2005, titled “Tournament System and Method of Operation Thereof” a tournament system is disclosed for conducting a multiplayer tournament, in which a plurality of players compete in a multiplayer game to determine a winner thereof, and which comprises a gaming server and a number of internet-enabled computer workstations for conducting a number of online eliminations rounds of the multiplayer game. Each online elimination round includes a plurality of online instances of the multiplayer game. The gaming server is arranged to determine a winner for each online instance of the multiplayer game. The gaming server also provides for conducting a plurality of successive online elimination rounds of the multiplayer game and enable only the winner of each online instance of the multiplayer game in any online elimination round to participate in an immediately succeeding online elimination round.

With reference to SG application no. SG11201910178SA by CHANNELFIX COM LLC dated Mar. 30, 2018, titled “VIDEO-TOURNAMENT PLATFORM” a method is disclosed for conducting a tournament which includes activating a competition, receiving video submissions from a plurality of content providers, and transmitting a compensation amount to at least a subset of the content providers, each having provided an acceptable video submission. The acceptable video submissions are assigned a seed-position and published based on the assigned seed positions to a plurality of voters. A winning content provider is determined based at least in part on votes received, and a prize is transmitted to the winning content provider. The compensation amount provided to each of the content providers obviates the prize from being construed as a lottery. The method can further include gaming-avoidance and anti-fraud features. League structures can be created to increase user retention and add relevancy of each competition to a user's continued experience on the platform.

With reference to KR application no. KR100964455B1 by Youngjun Kim dated Nov. 3, 2009, titled “System for tournament online game with batch progress,” a tournament online game system is disclosed in a batch type progress for performing objectivity and fairness of a game to easily and simply implement the repeated reproduction of the game by applying a batch-process type match operating method. An information providing unit transmits joining conditional information to a client. A sequence number generating unit generates sequence numbers if the participating application is completed. A match information processor transmits the camping opposite to each other information with each client. A variable input unit receives the variable information from clients. A victory operator decides the participant of the decision criterion information.

With reference to JP application no. JP2008279258A by Nhn Corp, NHN Corporation dated May 9, 2008, titled “User holding tournament game proceeding system and its proceeding method,” a user holding tournament game proceeding system and its proceeding method is disclosed. The user holding tournament game proceeding method of this reference includes the step of receiving a tournament game opening application including information on the number of people and a participation money from a user, the step of allotting a game room by which the number of people is designated to the user, the step of posting the information on the number of people and the participation money for the game room allotted to the user to connected waiting people and receive a participation application for the game room from the waiting people, the step of making the waiting people who applied for participation participate in the game room as gamers, and the step of proceeding the tournament game making the initial game money of respective gamers within the game room the same based on the participation money when the number of people of the gamers participating in the game room becomes the same as the designated number of people.

With reference to US application no. US20130065693A1 by Multimedia Games Inc dated Sep. 7, 2012, titled “Multi-site tournament gaming method and system,” a multi-site tournament gaming system and method are disclosed wherein multiple casino operators are engaged to initiate a series of player qualifying events and to hold a multisession tournament of the qualified players to determine the site winners; and, a final tournament is operated wherein the site winners are provided prizes and compete to be named the ultimate champion.

The problem of joining where users could join at any point of time in the match.

However, none of the above-discussed inventions provides such a tournament application system and method of participation/operation thereof.

At least one object of the present invention is to provide a tournament application system and method of participation/operation thereof.

Another object of at least one embodiment of the present invention is to provide a tournament application system, that allows teams to of unequal strength to match up against each other and provide an option where players can join at any stage of the game.

Another object of at least one embodiment of the present invention is to provide a team, that can have an equal or unequal number of players participating in each team.

Another object of at least one embodiment of the present invention is to provide a tournament application system that provides tournaments, which have multiple teams in each game, such as 2 and 4 team games.

Another object of at least one embodiment of the present invention is to provide a tournament application system in which players can join at any stage of the tournament which makes it unique.

Another object of at least one embodiment of the present invention is to provide a tournament application system started with a format where tournaments can be run for 24 hours, and users could join at any point of time in the match.

### SUMMARY OF THE INVENTION

According to one aspect of the present invention, a tournament application system is disclosed which comprises an application system having a computing system capable of interacting with a plurality of users; a server including a module arranged to interact with a plurality of users to operate a game containing a plurality of levels, said system being arranged to operate a tournament structure, wherein the tournament includes a number of rounds.

In another aspect of the invention, a method of participation/operation of tournament application is disclosed which includes the steps of: a) the user(s) can take part in an event by grouping themselves into teams; b) the players can join at any stage of the tournament; c) the tournament application system provides a short tournament in a team format where the teams can be of equal or unequal strength (e.g., number of players, overall skill level, etc.)

In another aspect of the invention, teams can have an equal or unequal number of players participating in each team.

In another aspect of the invention, wherein tournaments can have multiple teams in each game, such as, for example, 2 and 4 team games.

In another aspect of the invention, players can join he tournament at any stage of the tournament.

In another aspect of the invention, different tournaments may be provided with different entry fees on the app.

The systems, methods and/or code instructions stored in a storage device executed by one or more processors described herein provide a technical solution to the technical problem of providing a tournament-structured game, and in particular, a tournament-structured game that wherein players are able to join the tournament at any stage or round of the game. For example, in comparison to other games which do not provide such functionality, structure or opportunity.

The technical problem may, for example, relate to establishing a tournament-style game where players may want to form teams and/or join through the different stages or rounds of the game. The technical solution provided by systems, methods and/or code instructions stored in a storage device executed by one or more processors described herein is based on developing a tournament-style game where players are able to form teams (of equal or unequal members) and which allows players to join the tournament-style game at any point. More specifically, the server is configured to perform serval operations in order to operate the tournament structured or tournament-style game, including by being configured to group each of the plurality of players into one of a plurality of teams, generate a plurality of game cards each representing a different tournament structured game, and to transmit said plurality of game cards to said plurality of user devices for display therein. Each of the game cards comprises: a game title, a time indicating when the corresponding tournament structured game ends, an indication of a wining prize awarded to at least one winner of the tournament structured game, a number of participants allowed for each tournament structured game, details for at least one team participating in the tournament structured game, and an entry fee to join the corresponding tournament structured game. Furthermore, the server is also configured to allow a new player, a current player, or a player who had previously joined the tournament to join the tournament structured game at any stage (including during any round, before or after any round, etc.) of the tournament structured game. A new player may be defied as a player who has not previously joined the tournament structured game.

These and other objects, features and advantages of the present invention will become more apparent when the drawings as well as the detailed description are taken into consideration.

### BRIEF DESCRIPTION OF DRAWINGS

Reference will be made to embodiments of the invention, examples of which may be illustrated in accompanying figures. These figures are intended to be illustrative, not limiting. Although the invention is generally described in the context of these embodiments, it should be understood that it is not intended to limit the scope of the invention to these particular embodiments.

FIG. 1 illustrates a tournament application system, as per an embodiment of the present invention.

FIG. 2 illustrates a method of participation/operation of tournament application, as per an embodiment of the present invention.

The referral numerals in the figures refer to: 1—a tournament application system; 2, 3, 4 a method of participation/operation of tournament application.

Like reference numerals refer to like parts throughout the several views of the drawings provided herein.

### DETAILED DESCRIPTION OF THE INVENTION

The present invention will now be described hereinafter with reference to the accompanying drawings, in which some, but not all embodiments of the invention are shown. While the following description details the preferred embodiments of the present invention is not limited in its application to the details of construction and arrangement of the parts illustrated in the accompanying drawings. With reference to the figures, the enclosed description and drawings are merely illustrative of preferred embodiments and represent several different ways of configuring the present invention. Although specific components, materials, configurations, and uses of the present invention are illustrated and set forth in this disclosure, it should be understood that a number of variations to the components and to the configuration of those components described herein and in the accompanying figures can be made without changing the scope and function of the invention set forth herein.

The present invention proposes a tournament application system and method of participation/operation thereof.

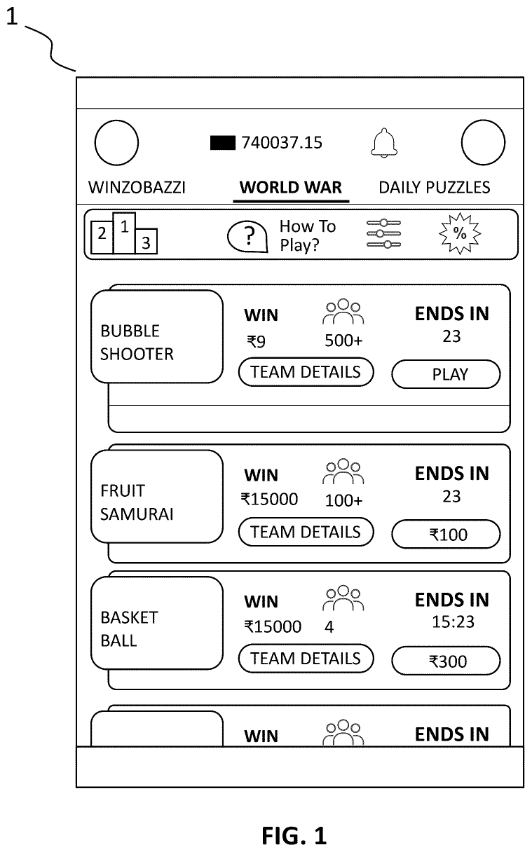

The present invention as illustrated in FIG. 1 provides at least one embodiment of the invention which includes a tournament application system. Tournament application system comprising an application system having a computing system capable of interacting with a plurality of users; a server including a module arranged to interact with a plurality of users to operate a game containing a plurality of levels, said system being arranged to operate a tournament structure, wherein the tournament includes a number of rounds.

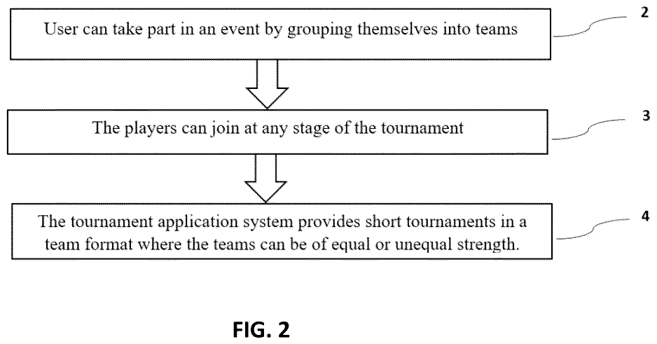

The present invention as illustrated in FIG. 2 provides another embodiment of the invention which includes a method of participation/operation of tournament application includes the steps of: a) user can take part in an event by grouping themselves into teams; b) the players can join at any stage of the tournament (including but not limited to before any round, during any round or after any round of the tournament); c) the tournament application system provides short tournament in a team format where the teams can be of equal or unequal strength.

In another embodiment the invention provides a tournament application system, wherein people can take part in an event by grouping themselves into teams. These teams can have an equal or unequal number of players participating in each team. The tournament application system provides tournaments, which have multiple teams in each game, such as 2 and 4 team games. Additionally, the players can join at any stage of the tournament which makes it unique. If any user looks at cricket or football, both teams have an equal number of players, and all the players are there from the beginning.

In another embodiment, the tournament application system allows teams of unequal strength to match up against each other and provide an option where players can join at any stage of the game. The tournament application system copies of any pictures, flowcharts, drawings, or sketches, which set forth users most current configuration.

In another embodiment, different tournaments with different entry fees are shown on the app (e.g., an application accessible on a user computing device, such as a mobile phone, mobile device, tablet, computer etc., which communicates with the tournament server(s)). The time when the tournament ends is also mentioned on the game card (e.g., a preview or description of the game or tournament). Different games may require different skill sets, such as but not limited to hand-eye coordination, dexterity, problem solving, etc. Based on this, a user can decide in which tournament(s) to participate.

In another embodiment, games like cricket follow a format where users are equally divided into teams and all players have to be present from the start of the tournament.

In another embodiment, the tournament application system includes, starts with or otherwise implements a format where one or more tournaments can be run continuously for example for 24 hours, and users are able to join the tournament at any point of time in the match (e.g., after the match has started) and the teams would be of equal sizes by use of an algorithm.

In another embodiment, the tournament application system can be configured to reduce the timings or length of the one or more tournaments to a few minutes, e.g., based on user feedback. Furthermore, the tournament application system may add or include a functionality wherein the teams can be of unequal strength, skill level, number of players, etc. Furthermore, the tournament application system of at least one embodiment may offer short tournaments in a team format where the teams can be of equal or unequal strength.

In another embodiment, the tournament application system, which provide a solution, which makes it easier for people to come and participate in the tournaments. This can also encourage people, especially in India, to start taking interests in such sports which do not enjoy the kind of popularity like cricket etc. This can then lead to promotion of sporting culture in the country by encouraging the viewership of less popular sports.

In another embodiment, the tournament application system displays a list of different games at different price points. Different games require different skill sets to master. Based on this, a user can decide which tournament to participate in.

In another embodiment, the tournament application system can be used to provide a better user experience for arcade/casual/strategy/racing games and etc., and can enable users to compete with their friends and other users across the country and test their skill.

In another embodiment, the teams can have an equal or unequal number of players participating in each team.

In another embodiment, the one or more tournaments implemented by the system and method can have multiple teams in each game, such as, for example, 2 and 4 team games.

In another embodiment, players can join the game(s) or tournament(s) at any stage of the tournament.

In another embodiment, different tournaments with different entry fees are shown on the app, which may include a mobile application accessible by the user's computing device (e.g., mobile phone, mobile device, tablet, gaming system, laptop computer, desktop computer, etc.)

In another embodiment, the time when the tournament ends may also be mentioned or listed on the game card and/or otherwise in the description or summary of the game or tournament accessible on the app and user's computing device.

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the disclosure and claims appended.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

1. A tournament application system comprising:
a server, said server arranged to interact with a plurality of user devices to operate a tournament structured game,
wherein the tournament structured game is defined as comprising a number of rounds,
said server being configured to:
group each of a plurality of players into one of a plurality of teams, wherein each of the plurality of players participate in said tournament structured game through the use of a different one of said plurality of user devices,
generate a plurality of game cards, each representing a different tournament structured game, and transmit said plurality of game cards to said plurality of user devices for display thereon,
wherein each of the plurality of game cards comprises: a game title, a time indicating when the corresponding tournament structured game ends, an indication of a wining prize awarded to at least one winner of the tournament structured game, a number of participants allowed for each tournament structured game, details for at least one team participating in the tournament structured game, and an entry fee to join the corresponding tournament structured game, and
allow a new player to join the tournament structured game at any stage, prior to, during or after any one of the number of rounds, of the tournament structured game, the new player being defined as a player that has not previously joined the tournament structured game.

2. The tournament application system as recited in claim 1, wherein each of the plurality of teams have an equal number of players.

3. The tournament application system as recited in claim 1, wherein at least some of the plurality of teams have an unequal number of players.
